(19) United States
(12) Patent Application Publication
(10) Pub. No.: US 2023/0251346 A1
(43) Pub. Date: Aug. 10, 2023

(54) Radar-Based Detection of Objects on Floor

(71) Applicant: Pilz GmbH & Co. KG, Ostfildern (DE)

(72) Inventors: Stefan Loy, Ostfildern (DE); Onedin Ibrocevic, Ostfildern (DE); Martin Bellingkrodt, Ostfildern (DE)

(21) Appl. No.: 18/164,812

(22) Filed: Feb. 6, 2023

(30) Foreign Application Priority Data
Feb. 7, 2022 (DE) 102022102784.8

(51) Int. Cl. G01S 7/02; E04B 5/46; E04F 13/074; E04F 15/024; G01S 13/04; G01S 7/41

(52) U.S. Cl. CPC G01S 7/027; E04B 5/46; E04F 13/074; E04F 15/02405; E04F 15/02494; G01S 7/41; G01S 13/04; G01S 13/66

(57) ABSTRACT

A floor panel has a bottom side and a walkable top side opposite the bottom side. An apparatus for detecting an object on the floor panel includes a holder that is mounted on, in, or under the floor panel. The apparatus includes a radar device configured to emit a radar signal, detect a radar echo reflected from the object, and provide a data signal based on the radar echo. The holder is configured to hold the radar device. A method for detecting the object on the floor panel includes, using the radar device, emitting a radar signal. The method includes, using the radar device, detecting a radar echo reflected from the object. The method includes providing a data signal based on the radar echo.

### CROSS-REFERENCE TO RELATED APPLICATIONS

This application claims priority to German Application No. 10 2022 102 784.8 filed Feb. 7, 2022, the entire disclosure of which is incorporated by reference.

### FIELD

The present invention relates to detecting objects using radar and more particularly to detecting objects on floor panels using radar.

### BACKGROUND

The ongoing digitalization of manufacturing systems not only enables greater flexibility in production, it also leads to the use of networked and intelligent technical systems in which and with which people work. Especially due to increasing interaction between humans and robots or machines, sensor systems and measurement methods for automatic and safe person recognition are becoming more and more important. In this context, good working conditions and safety for people are increasingly being discussed, especially in the context of Industry 4.0 and “ambient intelligence”. To ensure safe interaction between man and machine in a work process, it must always be ensured that the human body is reliably detected.

Individual machines and robots are often already equipped with appropriate sensors. However, in production halls where various work processes take place using multiple machines, where automated guided vehicles (AGVs) are also used, for example, a more global monitoring system is required in addition to the sensor technology that individual machines may offer. The global monitoring system should monitor all running processes as far as possible, i.e., it should be designed to cover a wide area and protect the people working there from hazards in a forward-looking manner. The problem is that different machines often use different sensor systems, such as laser or radar systems, which are neither compatible with each other nor can they be networked. Furthermore, in the case of machines or systems that move in space, it is hardly possible to ensure sufficient safety with such individual sensor systems.

In addition to the increasing digitalization in production itself, it can also be observed that ever greater flexibility is being demanded of the localities for production processes. A place on the factory floor, where product A is manufactured today, may be use for another product B the next day. This is another reason why safety technology should not be tied to a single machine in the future, as it has been in the past, but instead safety technology will be required on a large scale and needs to be flexibly modifiable in production. In order to meet these requirements, the production facilities must also meet the increasing demands for flexibility. As a result, increasingly sophisticated infrastructure concepts are being used. In order to prevent, for example, a vast amount of cables and wires that go hand in hand with increasing digitalization from ending up as a tangle of cables on the floor of a production hall, they are increasingly being tucked away in the floor under a floor panel. Thereby, cables and wires are out of the way and can still be easily accessed if needed by lifting an appropriate floor panel.

The above infrastructure system is already widely used for monitoring production processes. For example, it is known that floor panels can be equipped with weight sensors for the detection of objects, especially people. However, the problem arises here that weight sensors can only detect a weight or a change in weight. Thus, it remains unclear by what kind of object the weight or the change is caused. It is therefore not possible to distinguish whether a change in weight on a floor panel is caused, for example, by a pallet truck or the like driving over it or by a person walking on it. Consequently, the known system cannot reliably protect humans from hazards caused by machines while ensuring a smooth production and/or logistics process.

Although camera-based systems are also known with which, with the use of appropriate software, it is possible in principle to distinguish between different types of objects, these systems are far from working reliably enough to be used meaningfully in operational processes, specifically for safety-related applications. In fact, such camera-based surveillance systems do not work with the desired reliability or are too expensive to be used in a meaningful way.

### SUMMARY

It is an object to provide an apparatus and system that enable detection of objects on a floor panel. Further, it is an object to provide an apparatus and system with which it is in principle possible to distinguish between types of objects (for example, to distinguish between humans and machines) on a floor. Yet further, it is an object to provide an apparatus that enables detection of objects on a floor panel that is inexpensive, reliable and easy to use.

According to an aspect of the present disclosure there is provided an apparatus for detecting an object on a floor panel having a bottom side and a walkable top side opposite the bottom side, the apparatus comprising: a holder that is mounted to, in or under the floor panel, and a radar device configured to emit a radar signal, detect a radar echo reflected from the object, and provide a data signal based on the radar echo, wherein the holder is configured to hold the radar device.

Thus, it is an idea of the present disclosure to provide an apparatus for detecting an object that can be easily integrated into already existing infrastructure systems and that uses radar technology to provide a low-cost sensor whose signal allows, in principle, to distinguish between different types of objects. In particular, person recognition can be performed using the apparatus.

The floor panel can be part of a floor or form the floor, for example, of a factory hall. The holder can be mounted externally on one side of the floor panel or the holder can be integrated into floor panel itself. The holder holds the radar device in a defined manner with respect to the floor panel. It is conceivable, for example, that the floor panel comprises a cavity or has a cavity beneath it, and the holder together with the radar device is arranged in the cavity. For the utilization of the apparatus, the structure of the floor panel can be basically of any design. In particular, the floor panel can be formed by several layers and a floor covering. The material of the layers can be selected in such a way that a defined beam propagation can be achieved, so that the best spatial resolution can be obtained. The holder can also be mounted under the floor panel, particularly to an object under the floor panel.

In particular, the radar device is configured to emit the radar signal through the floor panel and/or from the floor panel. The radar device can be any device capable of emitting radar beams (or a radar signal) and receiving radar beams (or a radar echo). The radar device may be, for example, a radar antenna on a PCB (printed circuit board). Furthermore, the radar device can be an integrated circuit (IC). The aperture angle of the radar cone emitted by the radar device can be 90° and more. In principle, the larger the aperture angle, the wider the area at which objects can be detected.

In principle, it is conceivable that a holder can accommodate several radar devices. Further, it is conceivable that a plurality of mounts and radar devices are mounted on, in, or under a floor panel, or on or in a support of the floor panel. On the one hand, this ensures that as much space as possible is reliably detected via radar. Secondly, such an arrangement allows redundant monitoring of the space above the floor panel, which can increase the reliability of the device or system. Redundant design, for instance, enables higher safety categories and performance levels to be covered.

The distance between the holder and the floor panel and/or the distance between the radar device and the floor panel can be predetermined. Thereby, the radar devices emit the radar beams in a defined path and manner. This allows the size of the space to be monitored above the floor panel to be set in a defined manner.

Furthermore, the apparatus can be retrofitted into existing systems in a simple manner. In fact, all that needs to be done is to add a holder and a radar device to an existing floor system (for example, a raised floor system). The radar device makes it possible to detect and recognize objects in a room in a favorable manner and thus to foresee dangers to people and to send out appropriate warning signals or have them sent out. Moreover, the apparatus can be installed in such a way that it does not interfere in any way. The apparatus allows existing infrastructures to be better utilized.

In a refinement, the holder is mounted on the bottom side of the floor panel or on the top side of the floor panel. Mounting the holder on the top side of the floor panel has the advantage that the radar signals do not interfere with floor panel when emitted away from the floor panel. In other words, in this case, the material of the floor panel can be freely chosen. In particular, the material of the floor panel may also be a material that permits only a few or no radar beams to pass through. Mounting the holder on the bottom side of the floor panel, which, in contrast to the top side of the floor panel, is not walked on, has on the other hand the advantage that the radar device is mounted in a protected area where no one can step on it.

In another refinement, the holder can be mounted to a support of the floor panel, in particular on a side of the support which is connected to the floor panel, or the holder can be mounted into a support of the floor panel. The support is arranged under the floor panel and supports the floor panel from below. The holder can be mounted on the support or it can be integrated into an upper surface of the support, wherein the upper surface of the support is preferably parallel to or even with the top side surface of the floor panel. The support may also comprise a cavity into which the radar device can be inserted.

In various embodiments the holder can be a carrier film, a carrier plate, a cup-shaped element, a funnel-shaped element, and/or a tray-shaped element. For example, the holder may be a carrier film to which a radar device in the form of a conductive copper foil is applied. The carrier film may comprise an adhesive layer so that it can be glued to the floor panel, for example. It is also conceivable that the carrier film is statically charged and thereby connected to the floor panel. Nevertheless, the holder may also be a carrier plate in the form of a circuit board on which the radar device is mounted. However, the mount may equally comprise a more voluminous body such as a shell configured to enclose and hold the radar device. This is particularly advantageous when the radar device is large due to the need for stronger radar signals.

In a further refinement, the holder can be mounted (to the floor panel and/or support) with a fastening means. In particular, the holder can be screwed, nailed, riveted, adhered or clamped to the floor panel and/or support, or printed onto the floor panel. For example, the holder may include a basket or cage into which the radar device is placed and which is attached to the bottom side of the floor panel with screws or nails. Nevertheless, it is also conceivable that the holder comprises a magnetic material configured to be attached to the floor panel or the support magnetically. Static adhesion or adhesive adhesion are also possible. Further, the holder may include, for example, a clamp, ferrule, or the like that may be clamped to the support. In addition, it is conceivable that the holder (preferably together with the radar device) is printed directly onto or embossed into the floor panel.

In a further refinement, the apparatus comprises an aperture configured to block and/or redirect a portion of the radar signal from the radar device. In other words, the aperture can be designed to focus the radar beams of the radar device. For example, the aperture can include a metal jacket that is wrapped around the radar device and blocks radar signals emitted in the direction of the jacket. The distance between the aperture and the holder is preferably adjustable.

In a preferred refinement, the holder includes the aperture. For example, the aperture can be integrated into a wall of a pot-shaped holder. However, the aperture can also be designed as a plate or foil, which is attached to the holder.

In a further refinement, the apparatus further comprises the floor panel and/or a support(s) for the floor panel. In this case, the holder is connected to the floor panel and/or the support, preferably in a detachable manner. However, it is also conceivable that the floor panel itself forms the holder. In such a case, the radar device can be arranged directly in or on the floor panel. In particular, the radar device can be printed (directly) onto the floor panel. In the case where the radar device is placed on the top of the floor panel, the material(s) of the floor panel can be chosen freely. Possible materials for the floor panel include metal (especially steel), plastic, glass, wood or concrete.

In a preferred refinement in which the apparatus includes the floor panel and/or support, the floor panel and/or support is permeable to the radar signal and the radar echo, at least in certain areas. In other words, the floor panel and/or support has, at least in some areas, a permittivity equal to or greater than a minimum permittivity. That is, the floor panel or support is designed so that the radar beams from the radar device are not completely blocked. The minimum permittivity depends on the material. Furthermore, the minimum permittivity depends on the used frequency of the radar signal. Preferably, the entire floor panel has a permittivity equal to or greater than a minimum permittivity. The minimum permittivity must be such that the distance, direction, speed or type of the object to be detected can still be reasonably deduced from the radar echo received.

In a further refinement, the floor panel and/or support is part of a raised floor system, the raised floor system preferably complying with DIN EN 12825. It is also conceivable that the device comprises the raised floor system. A raised floor system is generally understood to be a system comprising at least one floor panel facing the floor of a room (preferably parallel) at a predefined distance. The floor panel is supported by one or more supports (of the raised floor system) or the floor panel is supported on one or more supports. In principle, a floor system is also conceivable in which several floor panels face a floor in parallel and in a spaced-apart manner.

According to a further aspect of the present disclosure, there is provided a system for detecting an object on a floor panel, the system comprising: the described apparatus, and data processing device that is configured to receive the data signal from the radar device and to determine from the data signal at least one of: (i) a distance of the object with respect to the floor panel and/or a support(s) for the floor panel, (ii) a direction of the object with respect to the floor panel and/or support, (iii) a speed of the object, and (iv) a type of the object.

The data processing device can be integrated into the apparatus. For example, the data processing device can be integrated into the holder or support, or it may be attached to the floor panel (preferably to the underside of the floor panel). Nevertheless, the data processing device may also be located remotely from the apparatus. The data processing device can be connected to the radar device with a cable or wirelessly.

In a refinement of the system, the data processing device is configured to classify the type of object, in particular to distinguish between a human and a non-living object. This allows the system to detect whether a person is in danger in the area of the radar device and to decide whether the system should emit a warning signal.

In another refinement of the system, the data processing device is configured to track a movement of the object. From the movement profiles of several objects, for example, an imminent danger can then be detected by extrapolating future movements. It is also conceivable that a movement profile is created for an object and that, when the object is detected again, a current movement profile is compared with an older profile in order to draw conclusions about any imminent dangers in the area of the radar device.

In a further refinement, the system may further comprise a radar reflector configured to be mounted on a side facing the top side of the floor panel and to receive the radar signal from the radar device and to reflect a corresponding radar echo. The radar reflector can be mounted, for example, on the ceiling of a room, such as a factory or exhibition hall. The radar reflector can be a triple mirror, for example. The use of a radar reflector has the advantage that it provides a defined radar echo if there are no objects in sight. When an object is present, this defined echo is then changed in a certain way. In other words, the radar reflector creates a defined reference echo. This allows objects to be detected more easily and precisely. In other words, in terms of functional safety, the use of the radar reflector can verify that the system is operating correctly. In particular, each time a measurement is made, i.e. each time the radar signal is emitted and the echo is received, confirmation is obtained that the system is working, even if there is no obstacle in the way.

According to a further aspect of the present disclosure, there is provided a method for detecting an object on a floor panel having a bottom side and a walkable top side opposite the bottom side, the method comprising: mounting a holder to, in, or under the floor panel, and providing a radar device in the holder, wherein the radar device emits a radar signal, detects a radar echo reflected from the object, and provides a data signal based on the radar echo. The holder can be mounted on or in a support (of the floor panel) under the floor panel and the radar device emits the radar signal through the floor panel and/or away from the floor panel and/or support.

It goes without saying that the features mentioned above and those to be explained below can be used not only in the combination indicated in each case, but also in other combinations or on their own, without leaving the scope of the present invention.

### BRIEF DESCRIPTION OF THE DRAWINGS

Embodiments of the invention are shown in the drawings and are explained in more detail in the following description.

FIG. 1 a simplified schematic diagram of a first embodiment of an apparatus according to this disclosure in a cross-sectional view.

FIG. 2 a schematic diagram of a second embodiment of an apparatus according to this disclosure in a cross-sectional view.

FIG. 3 is a schematic diagram of a third embodiment of an apparatus according to this disclosure in a cross-sectional view.

FIG. 4 is a schematic diagram of a fourth embodiment of an apparatus according to this disclosure in a cross-sectional view.

FIG. 5 is a schematic diagram of a fifth embodiment of an apparatus according to this disclosure in a cross-sectional view.

FIG. 6 is a simplified schematic diagram of a sixth embodiment of an apparatus according to this disclosure in a cross-sectional view.

FIG. 7 is an illustration of a seventh embodiment of an apparatus according to this disclosure in a perspective view.

FIG. 8 is a schematic diagram of a first embodiment of a system according to this disclosure in a side view.

### DETAILED DESCRIPTION

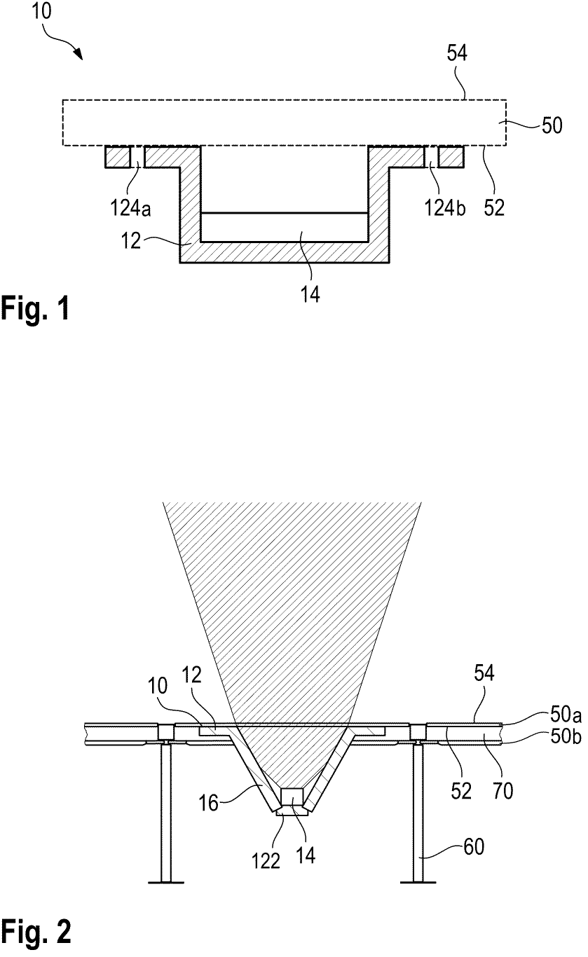

In FIG. 1, a first embodiment of an apparatus according to this disclosure is denoted in its entirety by reference numeral 10. The apparatus 10 comprises a holder 12 and a radar device 14 arranged in the holder 12. In this embodiment, the holder 12 is pot-shaped. The radar device 14 is attached to the bottom of the pot. The radar device 14 is configured to emit a radar signal in the direction of the floor panel 50 and through the floor panel 50. The holder 12 further comprises at least two openings 124a and 124b through which the holder 12 can be fastened to the bottom side 52 of the floor panel 50 using fastening means, such as screws or nails.

When the radar signal emitted by the radar device 14 is reflected as a radar echo by an object (not shown here) located on the top side 54 of the floor panel 50, and the radar echo is picked up by the radar device 14, it is possible to draw conclusions about the object 80 based on the shape of the radar echo or a data signal based thereon. In particular, it is possible to find out via the shape of the radar echo or data signal what the shape of the object 80 is and thus what type of object 80 it may be.

FIG. 2 shows a schematic diagram of a second embodiment of an apparatus 10 according to this disclosure in a cross-sectional view. Specifically, FIG. 2 shows a raised floor system 70 comprising a first floor panel 50a and a second floor panel 50b located at a predetermined distance below the first floor panel 50a. In addition to the first and second floor panels 50a and 50b, the raised floor system 70 further includes two supports 60 to which the corners of the floor panels are attached. In this embodiment, neither the two floor panels 50a and 50b nor the supports 60 are part of the apparatus 10, but embodiments in which these components are part of the apparatus are also conceivable.

Attached to the bottom side 52 of the floor panel 50a is the holder 12 of the apparatus 10. In this embodiment, the holder 12 is glued to the bottom side 52. The holder 12 passes through a recess in the second floor panel 50b. The holder 12 is funnel-shaped and includes a bottom side 122 on which the radar device 14 is disposed. The radar device 14 emits radar beams in the form of a cone in the direction of the floor panel 50. The wall side of the funnel-shaped bracket 12 acts as an aperture 16 (or comprises an aperture 16) and limits the opening angle of the wheel cone. Depending on the inclination of the aperture 16, the aperture angle can be reduced or increased and thus a smaller or larger space can be observed with the radar device 14.

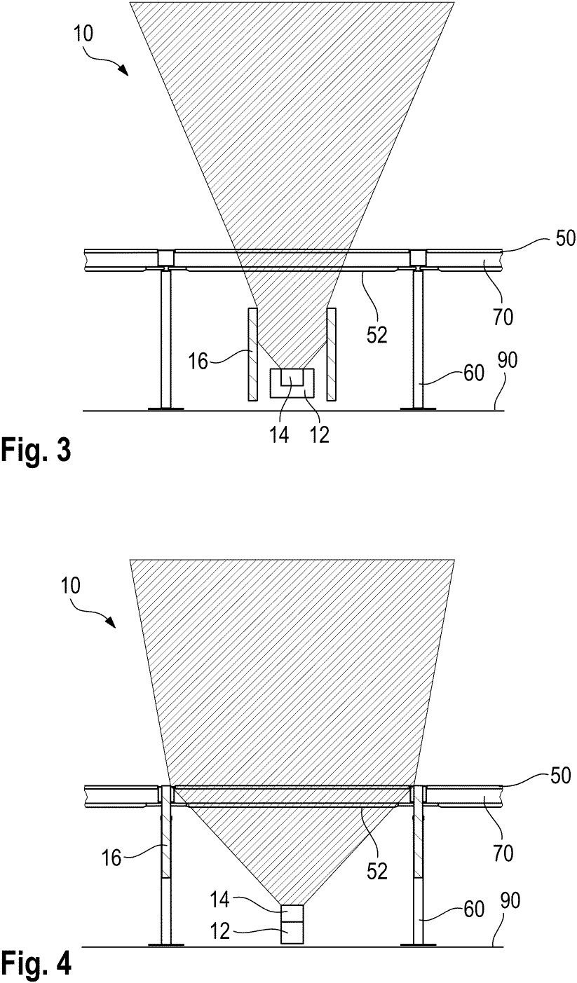

FIG. 3 shows a schematic diagram of a third embodiment of an apparatus 10 according to this disclosure in a cross-sectional view. In this embodiment, the apparatus 10 comprises a holder 12, a radar device 14 located therein, an aperture 16, a floor panel 50, and supports 60 that support the floor panel 50 at its edges. The floor panel 50 is part of a raised floor system 70.

The holder 12 is arranged under the floor panel 50, more specifically on a side facing the bottom side 52 of the floor panel 50. In fact, the support stands on a floor 90. The aperture 16 is arranged around the holder 12 and also stands on the floor 90. In this embodiment, the aperture 16 comprises a plurality of walls (two of which are shown in FIG. 3), each extending away from the floor 90 on the side of the holder 12 towards the floor panel 50. The material of the walls does not let the radar signal of the radar device 14 pass through. In present embodiment metal was selected as the material of the walls.

The walls of the aperture 16 are arranged to block a portion of the radar beams (or radar signal) emitted by the radar device 14, thereby reducing the aperture angle of the radar cone emitted by the radar device 14. Since the walls of the aperture 16 in this embodiment are freely adjustable and can be moved on the floor 90 in all directions, the opening angle of the radar cone is also adjustable and can be changed as required. By varying the opening angle of the radar cone, it is possible, in the case of several adjacently arranged radar devices, to achieve a defined overlap or non-overlap of the radar cones close above the floor panel 50. An overlap has the advantage that multiple radar echoes may include redundant information. This can increase the overall reliability of the apparatus 10 and objects can be detected and recognized more accurately.

FIG. 4 shows a schematic diagram of a fourth embodiment of an apparatus 10 according to this disclosure in a cross-sectional view. In contrast to the third embodiment shown in FIG. 3, in the fourth embodiment, the aperture 16 is integrated into the support 60 of the floor panel 50. More specifically, the support 60 includes a cavity in which the aperture16 is integrated. Since the arrangement of the supports is generally aligned with the size of the floor panel 50, the mobility of the aperture16 is limited in this embodiment. On the other hand, the apparatus 10 according to the fourth embodiment has the advantage that the aperture 16 is not in the way of anything and cannot slip or tilt in the support.

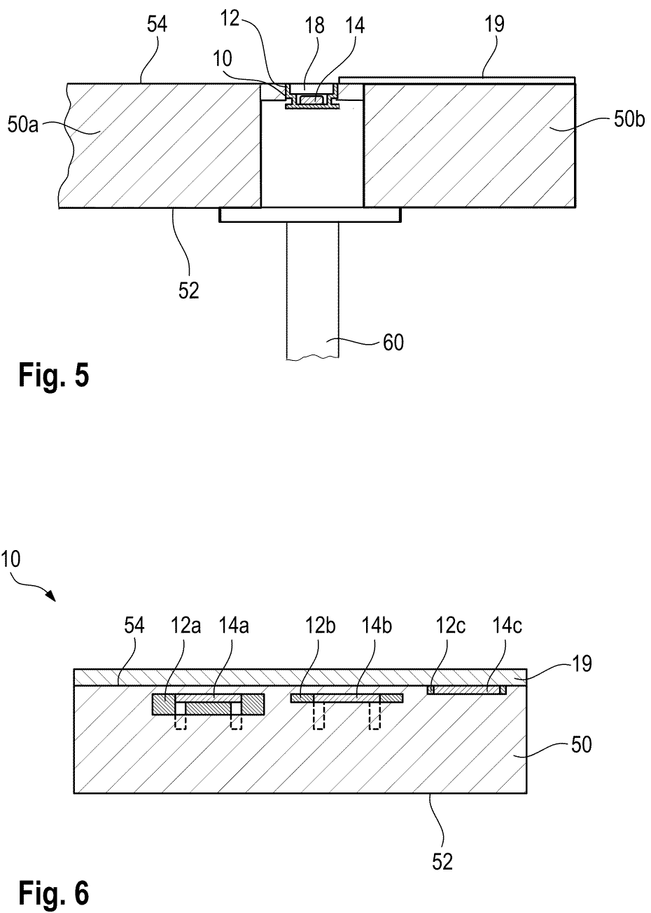

FIG. 5 shows a schematic diagram of a fifth embodiment of an apparatus 10 according to this disclosure in a cross-sectional view. FIG. 5 shows a support 60, a first floor panel 50a, and a second floor panel 50b, wherein each floor panel 50a, 50b is connected to the support 60. A floor covering 19 is applied to the second floor panel 50b. Neither the floor panels 50a, 50b, nor the floor covering 19 and the support 60 are part of the apparatus 10 in this embodiment. In fact, the apparatus 10 in this embodiment comprises only the holder 12 and the radar device 14, wherein the holder 12 is integrated into the support 60 in this embodiment. In particular, FIG. 5 shows a holder 12 that is integrated into a cavity at the top of the support 60. In this context, the upper side of the support 60 is to be understood as the side of the support 60 to which the floor panels 50a, 50b are attached. In this embodiment, the apparatus 10 further comprises a cover 18 for the radar device 14. The cover 18 should be made of a material that is permeable to radar beams or which includes areas through which the radar beams can pass through. Furthermore, the material should be robust, since the upper side of the support 60 should be able to be loaded with heavy equipment and should be accessible. For example, the cover 18 may include a hard plastic cap.

FIG. 6 shows a simplified schematic diagram of a sixth embodiment of an apparatus 10 according to this disclosure in a cross-sectional view. In this embodiment, the apparatus 10 comprises a floor panel 50, a first holder 12a that holds a first radar device 14a, a second holder 12b that holds a second radar device 14b, a third holder 12c that holds a third radar device 14c, and a floor covering 19 applied to the floor panel 50. The floor covering 19 comprises a material which is permeable to radar beams at least in the region of the radar devices 14a, 14b and 14c. In this embodiment, the signals emitted by the radar devices 14a, 14b, and 14c are of different frequency and/or signal strength. Thereby, objects of different types can be detected more precisely. The floor panel 50 shown in FIG. 6 can be part of a raised floor system. However, the floor panel 50 may just as well be arranged directly on a floor 90, i.e., without being spaced apart from the floor 90. In fact, the floor panel 50 may also be part of a floor 90 or form or comprise a floor 90. In principle, the holder 12 or the radar device 14 can also be printed directly onto the floor panel 50.

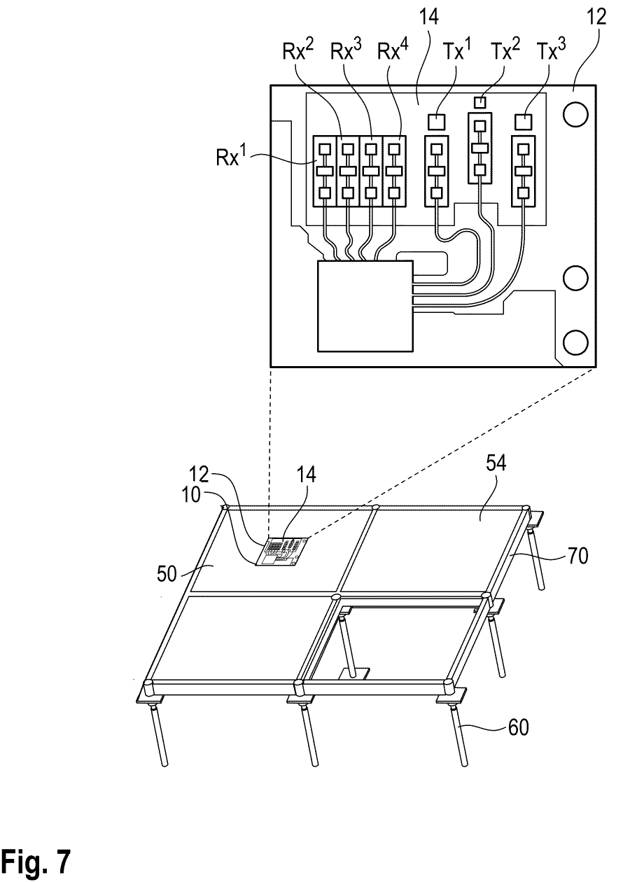

FIG. 7 shows a schematic diagram of a seventh embodiment of an apparatus 10 according to this disclosure in a perspective view. In particular, FIG. 7 shows a raised floor system 70 comprising a plurality of floor panels 50 supported by a plurality of supports 60. An apparatus 10 is shown on the top side 54 of one of the floor panels 50, which includes a holder 12 and a radar device 14. The holder 12 includes a carrier film or foil on which a radar device 14 is printed. As can be seen from the enlarged view, the radar device 14 includes a plurality of transmitters Tx for transmitting a radar signal and a plurality of receivers Rx for receiving a radar echo.

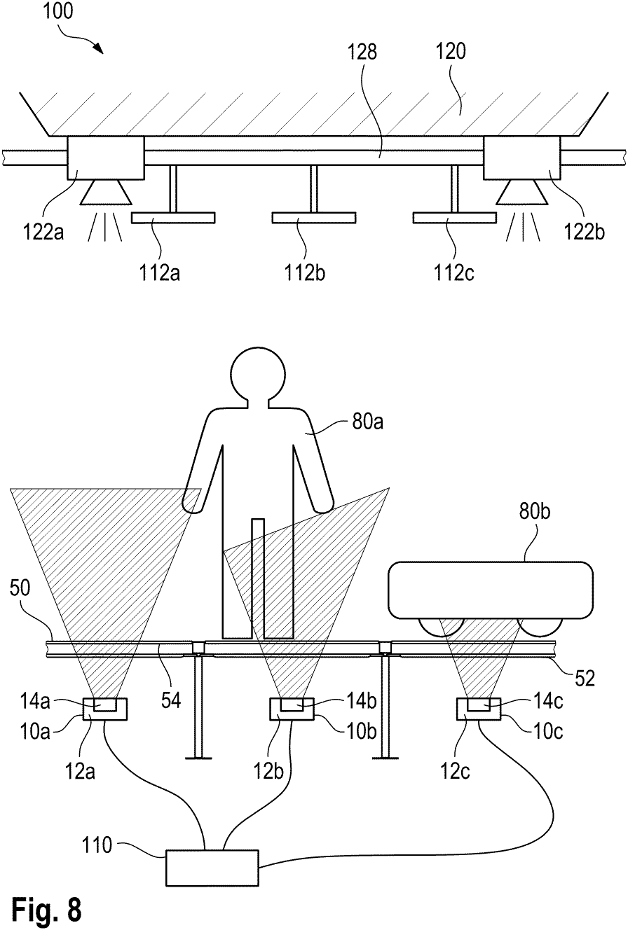

FIG. 8 shows a schematic diagram of a first embodiment of system 100 according to this disclosure in a side view. The system 100 includes three apparatuses 10a, 10b, and 10c, each comprising a holder (12a, 12b, 12c) and a radar device (14a, 14b, and 14c), and a data processing device 110 connected to the three apparatuses 10a, 10b, and 10c. Further, the system 100 includes three radar reflectors 112a, 112b, and 112c. These are mounted on a linkage 128 on a ceiling 120 (for example, of a factory hall) and are configured to receive radar signals emitted by the apparatuses 10a, 10b, and 10c and to return a radar echo corresponding to the respective radar signals. The linkage 128 may also be used to mount lighting devices 122a and 122b, for example. After receiving the radar echoes by the radar devices 14a, 14b, and 14c and providing data signals based on the radar echoes to the data processing device 110, the data processing device 110 determines from the radar echoes or data signals at least the velocity and shape (or type) of the objects 80a and 80b located on the ground sheets 50. In particular, the data processing device 110 is able to determine from the received echoes whether the objects 80a and 80b are living objects. From this, the data processing device 110 may further infer whether a human is at risk of danger, for example, from another detected moving object.

The phrase at least one of A, B, and C should be construed to mean a logical (A OR B OR C), using a non-exclusive logical OR, and should not be construed to mean “at least one of A, at least one of B, and at least one of C.”

Overall, the present invention is not limited by the examples of implementation presented here, but is defined by the following claims.

What is claimed is:

1. An apparatus for detecting an object on a floor panel having a bottom side and a walkable top side opposite the bottom side, the apparatus comprising:
a holder that is mounted on, in, or under the floor panel, and
a radar device configured to emit a radar signal, detect a radar echo reflected from the object, and provide a data signal based on the radar echo,
wherein the holder is configured to hold the radar device.

2. The apparatus of claim 1 wherein the holder is mounted on the bottom side of the floor panel or on the top side of the floor panel.

3. The apparatus of claim 1 wherein the holder is mounted to a support of the floor panel.

4. The apparatus of claim 3 wherein the holder is mounted to the support of the floor panel on a side of the support.

5. The apparatus of claim 1 wherein the holder is mounted into a support of the floor panel.

6. The apparatus of claim 1 wherein the holder includes at least one of a carrier film, a carrier plate, a cup-shaped element, a funnel-shaped element, and a tray-shaped element.

7. The apparatus of claim 1 wherein the holder is attached with fastening means.

8. The apparatus of claim 1 further comprising an aperture configured to at least one of block and redirect a portion of the radar signal from the radar device.

9. The apparatus of claim 8 wherein the holder includes the aperture.

10. The apparatus of claim 1 further comprising at least one of the floor panel and a support.

11. The apparatus of claim 1 further comprising the floor panel, wherein the floor panel is at least in some areas transparent to the radar signal and the radar echo.

12. The apparatus of claim 11 wherein the floor panel is part of a raised floor system.

13. The apparatus of claim 12 wherein the raised floor system complies with DIN EN 12825.

14. The apparatus of claim 1 further comprising a support that is at least in some areas transparent to the radar signal and the radar echo.

15. The apparatus of claim 14 wherein the support is part of a raised floor system.

16. The apparatus of claim 15 wherein the raised floor system complies with DIN EN 12825.

17. A system for detecting an object on a floor panel, the system comprising:
the apparatus of claim 1; and
a data processing device configured to receive the data signal from the radar device and to determine from the data signal at least one of: (i) a distance to the object with respect to the floor panel and/or a support of the floor panel, (ii) a direction of the object with respect to the floor panel and/or support, (iii) a speed of the object, and (iv) a type of the object.

18. The system of claim 17 wherein the data processing device is configured to classify the type of object to distinguish between a human and a non-living object.

19. The system of claim 17 wherein the data processing device is configured to track a movement of the object.

20. The system of claim 17 further comprising a radar reflector configured to be mounted on a side facing the top side of the floor panel, to receive the radar signal from the radar device, and to reflect a corresponding radar echo.

21. A method for detecting an object on a floor panel, the floor panel having a bottom side and a walkable top side opposite the bottom side, a holder being mounted to, in, or under the floor panel, the method comprising:
using a radar device arranged within the holder, emitting a radar signal;
using the radar device, detecting a radar echo reflected from the object, and
providing a data signal based on the radar echo.
